(19) United States
(12) Patent Application Publication
(10) Pub. No.: US 2025/0260023 A1
(43) Pub. Date: Aug. 14, 2025

(54) FUEL CELL STACK

(71) Applicant: TOYOTA JIDOSHA KABUSHIKI KAISHA, Toyota-shi (JP)

(72) Inventor: Joji AOCHI, Gotemba-shi (JP)

(73) Assignee: TOYOTA JIDOSHA KABUSHIKI KAISHA, Toyota-shi (JP)

(21) Appl. No.: 18/951,675

(22) Filed: Nov. 19, 2024

(30) Foreign Application Priority Data
Feb. 13, 2024 (JP) 2024-019475

(51) Int. Cl. H01M 8/0254; H01M 8/0267; H01M 8/0276; H01M 8/0284; H01M 8/04029; H01M 8/1004

(52) U.S. Cl. CPC H01M 8/0254; H01M 8/0267; H01M 8/0276; H01M 8/0284; H01M 8/04029; H01M 8/1004

(57) ABSTRACT

The cells of the fuel cell stack have an adhesive sheet between adjacent first cell and second cell. The pressure-sensitive adhesive sheet adheres the first separator of the first cell to the second separator of the second cell. The first separator of the first cell comprises ribs in the adhesive region of the adhesive sheet, the ribs being adhered to the flat surface of the second separator of the second cell by the adhesive sheet. The width of the flat surface is larger than the width of the rib base portion.

### CROSS-REFERENCE TO RELATED APPLICATION

This application claims priority to Japanese Patent Application No. 2024-019475 filed on Feb. 13, 2024, incorporated herein by reference in its entirety.

### BACKGROUND

### 1. Technical Field

The technology disclosed in the present specification relates to a fuel cell stack.

### 2. Description of Related Art

A fuel cell stack disclosed in Japanese Unexamined Patent Application Publication No. 2022-66778 (JP 2022-66778 A) includes a plurality of stacked cells. Each of the cells includes two separators and a membrane electrode assembly sandwiched between the two separators. An adhesive is disposed between each of the cells. The adhesive adheres the separators of adjacent cells to each other. A protrusion portion that protrudes toward the adhesive is provided in each of the separators. The protrusion portions are adhered to each other by the adhesive. A flow path through which a cooling liquid flows is formed by a space surrounded by the protrusion portions.

### SUMMARY

In the fuel cell stack disclosed in JP 2022-66778 A, the protrusion portions are adhered to each other by the adhesive. In the configuration, when a cell is displaced due to an impact from the outside or the like, the position of each of the protrusion portions may be displaced, and a sealing property of an adhesive surface may be reduced. Also, leakage occurs in the cooling liquid flow path.

A fuel cell stack of a first embodiment disclosed by the present specification includes
a plurality of stacked cells, and
an adhesive sheet.
Each of the cells includes
a first separator,
a second separator, and
a membrane electrode assembly sandwiched between the first separator and the second separator.
The cells include a first cell and a second cell adjacent to the first cell.
A cooling liquid flow path is provided between the first separator of the first cell and the second separator of the second cell.
The adhesive sheet adheres the first separator of the first cell and the second separator of the second cell.
The first separator of the first cell includes a protrusion portion within an adhesive region of the adhesive sheet.
The protrusion portion is adhered to a flat surface of the second separator of the second cell by the adhesive sheet.
The width of the flat surface is wider than the width of a base portion of the protrusion portion.

In the fuel cell stack, since the protrusion portion is adhered to a flat surface that is wider than the width of a base portion of the protrusion portion, leakage of a cooling liquid does not easily occur even if the protrusion portion is displaced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a fuel cell stack;

FIG. 2 is an exploded perspective view of a cell of a fuel cell stack;

FIG. 3 is a cross-sectional III-III view of FIG. 1;

FIG. 4 is a plan view of the first separator;

FIG. 5 is a cross-sectional view of III-III of FIG. 1 when cells 90 are stacked;

FIG. 6 is a cross-sectional view of VI-VI of FIG. 1 when cells 90 are stacked; and

FIG. 7 is an explanatory view of a flat surface according to a modified example.

### DETAILED DESCRIPTION OF EMBODIMENTS

Following Embodiment 1 above, additional configurations of the fuel cell stack disclosed herein are described below.

### Embodiment 2

The fuel cell stack of Embodiment 1, wherein:
The surface of the second separator of the second cell is flat over the entire adhesive region of the adhesive sheet.

### Embodiment 3

In the fuel cell stack according to any one of Embodiments 1 or 2,
Each cell surrounds the membrane electrode assembly, and has a frame sheet sandwiched between the first separator and the second separator,
The protrusion portion is provided in a range overlapping the frame sheet when seen along a stacking direction of the cells.

### Embodiment 4

The fuel cell stack according to any one of Embodiments 1 to 3,
The protrusion portion has a first annular portion extending in an annular shape along an outer peripheral edge of the first separator.

### Embodiment 5

In the fuel cell stack according to any one of Embodiments 1 to 4
The first separator of the first cell has a first through hole,
The second separator of the second cell has a second through hole,
The gas flow path is constituted by the first through hole and the second through hole,
The protrusion portion has a second annular portion extending annularly along the outer peripheral edge of the first through hole,
The second annular portion is bonded to the second separator in an annular region along the outer peripheral edge of the second through hole by the adhesive sheet.

### Embodiment 6

The fuel cell stack according to any one of Embodiments 1 to 5,
The pressure-sensitive adhesive sheet includes
Rubber sheet,
A first adhesive layer for bonding the rubber sheet and the first separator of the first cell,
A second adhesive layer for bonding the rubber sheet and the second separator of the second cell.

### Embodiment 7

The fuel cell stack according to any one of Embodiments 1 to 6,
The protrusion portion is a rib formed by a bent portion of the first separator.

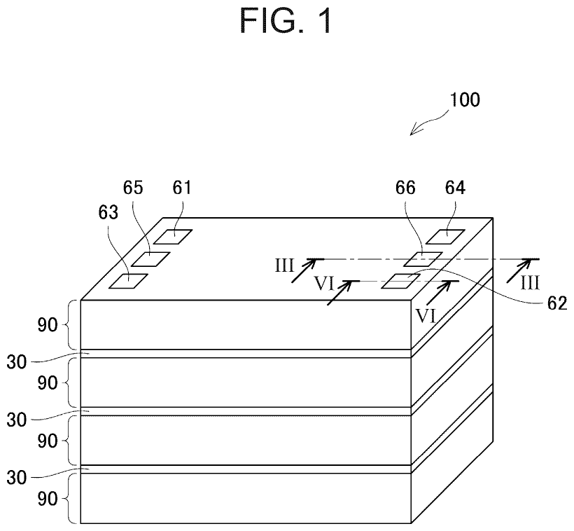

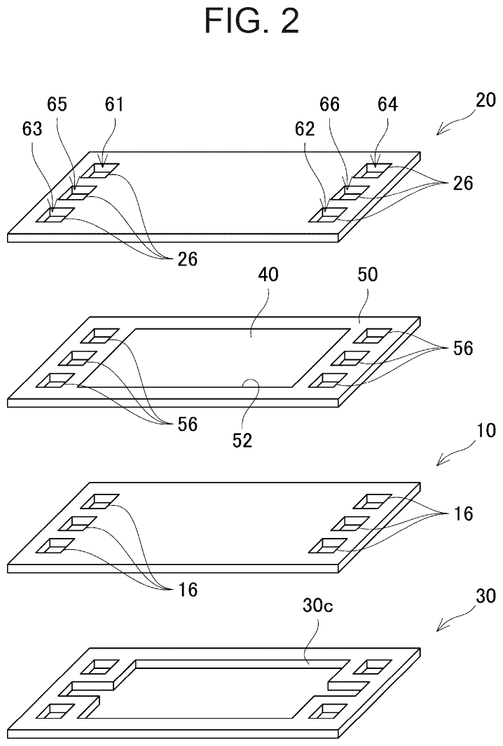

The fuel cell stack is mounted on, for example, a fuel cell electric vehicle using a fuel cell as a power source. The fuel cell stack 100 shown in FIG. 1 includes a plurality of stacked cells 90. As illustrated in FIG. 2, each cell 90 includes a first separator 10, a second separator 20, a membrane electrode assembly 40, and a frame sheet 50.

The membrane electrode assembly 40 generates electric power by reacting hydrogen with oxygen. Although not shown, the membrane electrode assembly 40 has a structure in which an electrolyte membrane is sandwiched between two catalyst layers. Examples of the material of the electrolyte membrane include an ion exchange membrane. Examples of the material of the catalyst layer include a material in which platinum nanoparticles are supported on carbon particles.

The frame sheet 50 is made of an insulating resin. As shown in FIG. 2, an accommodation hole 52 that penetrates the frame sheet 50 is provided in the center of the frame sheet 50. The membrane electrode assembly 40 is disposed in the accommodation hole 52. That is, the frame sheet 50 surrounds the membrane electrode assembly 40.

The first separator 10 and the second separator 20 are made of a gas impermeable conductive material. Examples of the material of the separator include a metal material such as stainless steel and a carbon material. The membrane electrode assembly 40 and the frame sheet 50 are sandwiched between the first separator 10 and the second separator 20. That is, the first separator 10 is in contact with one surface of the membrane electrode assembly 40 and the frame sheet 50. The second separator 20 is in contact with the other surface of the membrane electrode assembly 40 and the frame sheet 50. Hereinafter, a region overlapping with the membrane electrode assembly 40 when viewed along the stacking direction is referred to as a main region 45, and a region overlapping with the frame sheet 50 is referred to as an outer peripheral region 55.

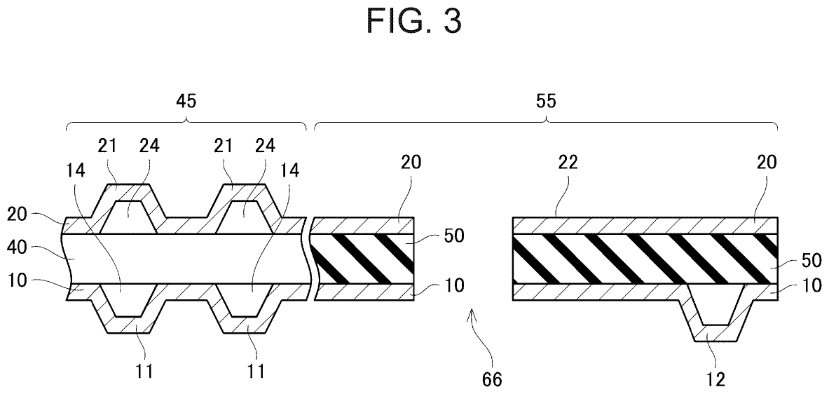

As shown in FIG. 3, the rib 11 is provided in the first separator 10 in the main region 45. The rib 11 is a portion protruding outward (i.e., on the opposite side of the membrane electrode assembly 40) due to bending of the first separator 10. The space between the rib 11 and the membrane electrode assembly 40 constitutes the hydrogen gas flow path 14. In the main region 45, the second separator 20 is provided with ribs 21. The rib 21 is a portion protruding outward (i.e., on the opposite side of the membrane electrode assembly 40) due to bending of the second separator 20. The oxidizing gas flow path 24 is formed by the space between the rib 21 and the membrane electrode assembly 40. Note that the oxidizing gas is a gas containing oxygen, and is air in the present embodiment.

As shown in FIG. 3, the rib 12 is provided in the first separator 10 in the outer peripheral region 55. The rib 12 is a portion protruding outward (i.e., on the opposite side of the frame sheet 50) by bending of the first separator 10. In the outer peripheral region 55, no rib is provided in the second separator 20. That is, in the outer peripheral region 55, the second separator 20 is flat. Hereinafter, the outer surface of the second separator 20 in the outer peripheral region 55 is referred to as a flat surface 22.

As shown in FIG. 2, the frame sheet 50 is provided with a plurality of through holes 56 around the accommodation hole 52. The first separator 10 is provided with a plurality of through holes 16. Each through hole 16 is located at a position overlapping with the through hole 56. The second separator 20 is provided with a plurality of through holes 26. Each through hole 26 is located at a position overlapping with the through hole 56. By connecting the through holes 16, 26, and 56, the flow path 66 is formed from the plurality of flow paths 61 penetrating the cell 90 in the thickness direction. The flow path 61 is a hydrogen gas supply path through which the hydrogen gas flows. The flow path 62 is a hydrogen gas discharge path through which the hydrogen gas flows. The flow path 63 is an oxidizing gas supply path through which the oxidizing gas flows. The flow path 64 is an oxidizing gas discharge path through which the oxidizing gas flows. The flow path 65 is a cooling liquid supply path through which the cooling liquid flows. The flow path 66 is a cooling liquid discharge path through which the cooling liquid flows. As shown in FIG. 1, a plurality of cells 90 are stacked to form a fuel cell stack 100. In the fuel cell stack 100, the flow paths 66 are connected to each other from the flow paths 61 of the cells 90. Therefore, the flow paths 61 to 66 extend along the stacking direction to both ends of the fuel cell stack 100. The hydrogen gas in the flow path 61 is discharged to the flow path 62 through the hydrogen gas flow path 14 of each cell 90. The oxidizing gas in the flow path 63 is discharged to the flow path 64 through the oxidizing gas flow path 24 of each cell 90.

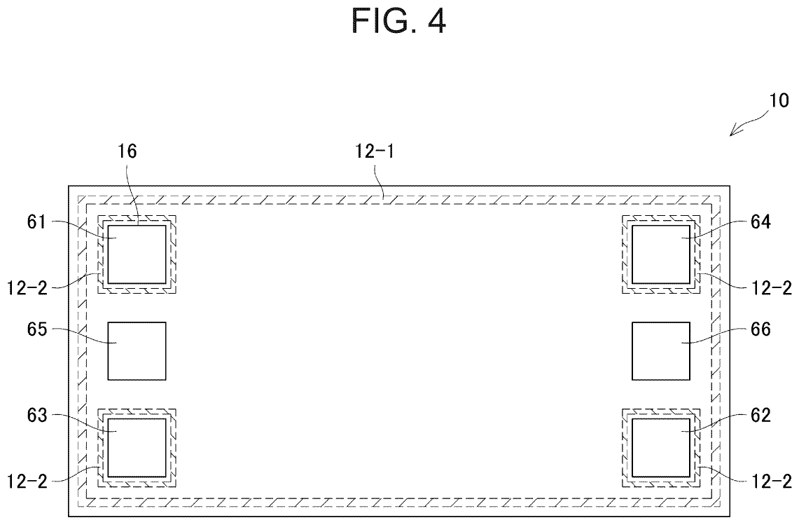

As illustrated in FIG. 4, the rib 12 includes an annular portion 12-1 and a plurality of annular portions 12-2. The annular portion 12-1 extends annularly along the outer peripheral edge of the first separator 10. Each annular portion 12-2 extends annularly from the flow path 61 along the outer peripheral edge of each through hole 16 constituting the flow path 64. The rib 12 is not provided around each of the through holes 16 constituting the flow path 66 from the flow path 65.

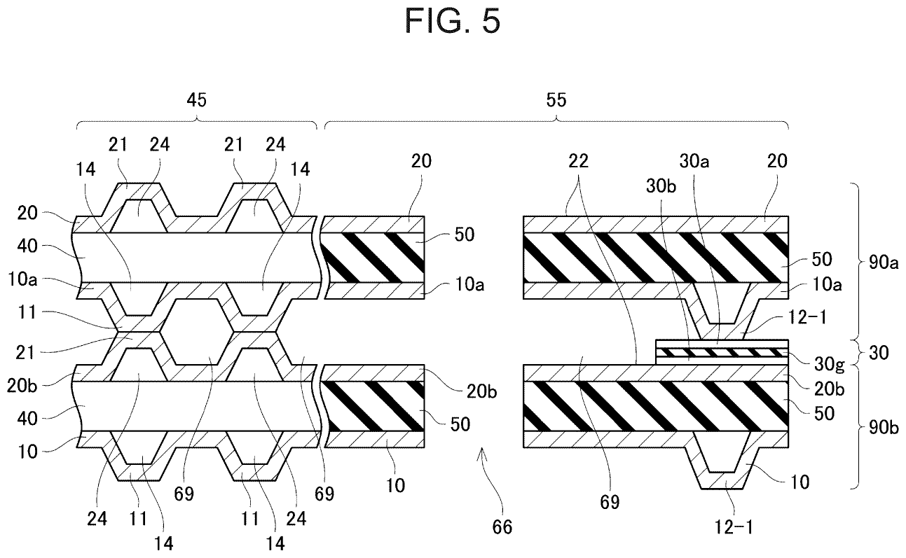

Next, a structure of a connection portion between adjacent cells 90 will be described. Since the structures of the connection portions are the same, the structure of the connection portion between the cell 90a and the cell 90b shown in FIG. 5 will be described below. In the following description, the first separator 10 of the cell 90a is referred to as a first separator 10a, and the second separator 20 of the cell 90b is referred to as a second separator 20b.

As shown in FIG. 5, the first separator 10a and the second separator 20b are arranged to face each other. The adhesive sheet 30 is sandwiched between the first separator 10a and the second separator 20b. The pressure-sensitive adhesive sheet 30 adheres the first separator 10a to the second separator 20b. The adhesive sheet 30 includes a rubber sheet 30g and adhesive layers 30a, 30b. The pressure-sensitive adhesive layers 30a adhere the rubber sheet 30g to the first separator 10a. The pressure-sensitive adhesive layers 30b adhere the rubber sheet 30g to the second separator 20b. That is, one surface of the pressure-sensitive adhesive sheet 30 is bonded to the first separator 10a, and the other surface of the pressure-sensitive adhesive sheet 30 is bonded to the second separator 20b.

As illustrated in FIG. 2, the pressure-sensitive adhesive sheet 30 is provided in the outer peripheral region 55 (that is, a region overlapping with the frame sheet 50). In the main region 45 (i.e., a region overlapping the membrane electrode assembly 40), the adhesive sheet 30 is provided with an opening portion 30c. The pressure-sensitive adhesive sheet 30 is provided in a range adjoining the outer peripheral edge of the first separator 10a and in a range surrounding each of the hydrogen gas supply path 61, the hydrogen gas discharge path 62, the oxidizing gas supply path 63, and the oxidizing gas discharge path 64. Within these ranges, the pressure-sensitive adhesive sheet 30 adheres the first separator 10a and the second separator 20b. The pressure-sensitive adhesive sheet 30 is not provided between the opening portion 30c and the cooling liquid supply path 65 and between the opening portion 30c and the cooling liquid discharge path 66.

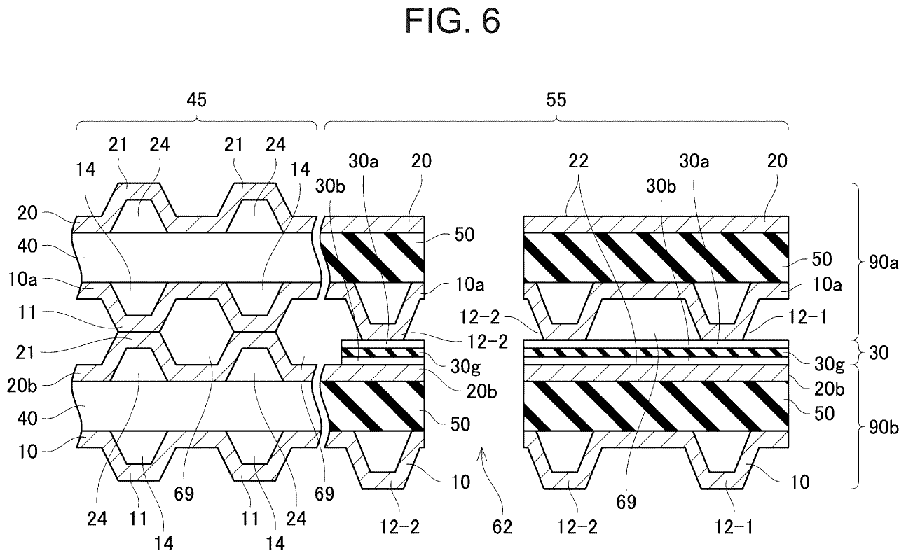

As shown in FIG. 5 and FIG. 6, in the outer peripheral region 55, the ribs 12 of the first separator 10a are bonded to the adhesive sheet 30. In the outer peripheral region 55, the flat surface 22 of the second separator 20b is bonded to the pressure-sensitive adhesive sheet 30. That is, in the adhesive sheet 30, the rib 12 of the first separator 10a and the flat surface 22 of the second separator 20b are bonded to each other in the area of the frame sheet 50. In other words, in the adhesive area of the pressure-sensitive adhesive sheet 30, the first separator 10a has ribs, and the second separator 20b has a flat surface 22.

As shown in FIG. 4, the ribs 12 of the first separator 10a have an annular portion 12-1. As shown in FIGS. 5 and 6, the annular portion 12-1 is adhered to the adhesive sheet 30. In addition, the flat surface 22 of the second separator 20b adheres to the pressure-sensitive adhesive sheet 30 within the annular portion 12-1. That is, the adhesive sheet 30 adheres the annular portion 12-1 to the flat surface 22. Between the first separator 10a and the second separator 20b is sealed within the annular portion 12-1.

As shown in FIG. 4, the ribs 12 of the first separator 10a have a plurality of annular portions 12-2. The annular portion 12-2 surrounds the respective peripheries of the flow paths 61 to 64. As shown in FIG. 6, the plurality of annular portions 12-2 are bonded to the adhesive sheet 30. In addition, the flat surface 22 of the second separator 20b adheres to the pressure-sensitive adhesive sheet 30 in the area of the plurality of annular portions 12-2. That is, the pressure-sensitive adhesive sheet 30 adheres the plurality of annular portions 12-2 to the flat surface 22. Between the first separator 10a and the second separator 20b is sealed within the plurality of annular portions 12-2.

As illustrated in FIG. 5 and FIG. 6, in the main region 45, the rib 11 of the first separator 10a and the rib 21 of the second separator 20b are in contact with each other. Thus, the first separator 10a and the second separator 20b are electrically connected to each other.

In the outer peripheral region 55, since the rib 12 is in contact with the flat surface 22, a space is provided between the first separator 10a and the second separator 20b at a part other than the rib 12. In the main region 45, since the rib 11 is in contact with the rib 21, a space is provided between the first separator 10a and the second separator 20b at a part other than the ribs 11 and 21. The cooling liquid flow path 69 is formed by the distance between the first separator 10a and the second separator 20b. The cooling liquid in the flow path 65 is discharged to the flow path 66 through the cooling liquid flow path 69 of each cell 90. The pressure-sensitive adhesive sheet 30 prevents leakage of the cooling liquid in the cooling liquid supply path 65 and the cooling liquid discharge path 66 in the annular portions 12-1 and 12-2.

The ribs 12 (i.e., the annular portions 12-1 and 12-2) are bonded to the flat surface 22 of the second separator 20b. Therefore, even if the cell 90a and 90b are displaced due to an external impact or the like, the sealing property of the adhesive surface is less likely to be deteriorated. Therefore, leakage of the cooling liquid is unlikely to occur in the cooling liquid flow path 69.

In the main region 45, the rib 11 of the first separator 10a and the rib 21 of the second separator 20b are in contact with each other. Since both sides of the ribs 11 and 12 are the cooling liquid flow paths 69, a high sealing property is not required at the interface between the rib 11 and the rib 12. Therefore, even if the rib 11 and the rib 12 are displaced due to an external impact or the like, leakage of the cooling liquid from the cooling liquid flow path 69 to the outside does not occur.

Further, in the above-described embodiment, the hydrogen gas flow path is provided on the first separator side, and the oxidation gas flow path is provided on the second separator side. However, an oxidation gas flow path may be provided on the first separator side, and a hydrogen gas flow path may be provided on the second separator side. That is, either the first separator or the second separator may be an anode.

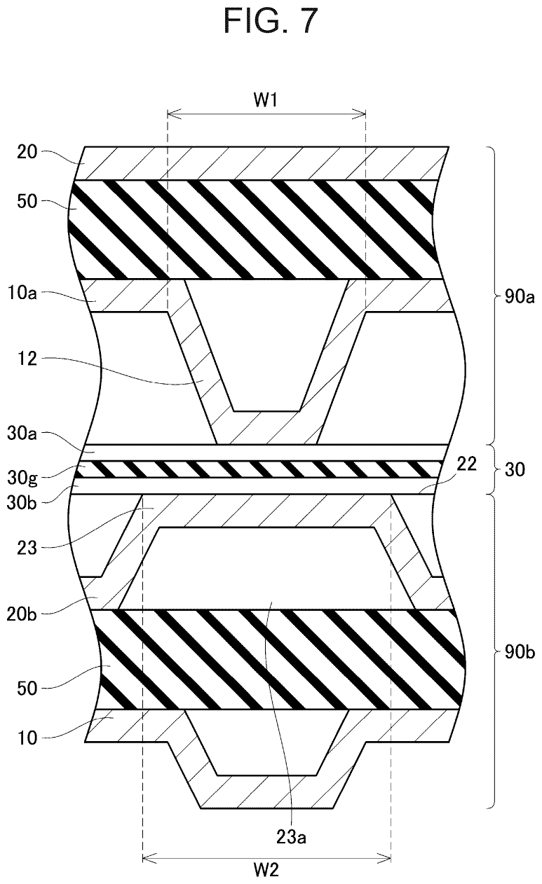

In the above-described embodiment, the entire surface of the second separator 20b was the flat surface 22 over the entire area where the pressure-sensitive adhesive sheet 30 was provided. However, as shown in FIG. 7, the flat surface 22 may be provided in any manner as long as the width W2 of the flat surface 22 of the second separator 20 (that is, the flat surface to which the rib 12 is bonded) is wider than the width of the base portion in the width W1 of the rib 12. For example, as shown in FIG. 7, the second separator 20 may be provided with a wide rib 23, and the end surface of the rib 23 may be a flat surface 22. Here, a reinforcing member may be provided on the inner area 23a of the rib 23.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A fuel cell stack comprising:
a plurality of stacked cells; and
an adhesive sheet, wherein:
each of the cells includes
a first separator,
a second separator, and
a membrane electrode assembly sandwiched between the first separator and the second separator;
the cells include a first cell and a second cell adjacent to the first cell;
a cooling liquid flow path is provided between the first separator of the first cell and the second separator of the second cell;
the adhesive sheet adheres the first separator of the first cell and the second separator of the second cell;
the first separator of the first cell includes a protrusion portion within an adhesive region of the adhesive sheet;
the protrusion portion is adhered to a flat surface of the second separator of the second cell by the adhesive sheet; and
a width of the flat surface is wider than a width of a base portion of the protrusion portion.

2. The fuel cell stack according to claim 1, wherein a surface of the second separator of the second cell is flat over an entirety of the adhesive region of the adhesive sheet.

3. The fuel cell stack according to claim 1, wherein:
each of the cells surrounds a periphery of the membrane electrode assembly and has a frame sheet sandwiched between the first separator and the second separator; and
the protrusion portion is provided in a range overlapping the frame sheet when seen along a stacking direction of the cells.

4. The fuel cell stack according to claim 1, wherein the protrusion portion has a first annular portion extending in an annular shape along an outer peripheral edge of the first separator.

5. The fuel cell stack according to claim 1, wherein:
the first separator of the first cell has a first through hole;
the second separator of the second cell has a second through hole;
a gas flow path is constituted by the first through hole and the second through hole;
the protrusion portion has a second annular portion extending in an annular shape along an outer peripheral edge of the first through hole; and
the second annular portion is adhered to the second separator in an annular region along an outer peripheral edge of the second through hole by the adhesive sheet.

6. The fuel cell stack according to claim 1, wherein the adhesive sheet includes
a rubber sheet,
a first adhesive layer that adheres the rubber sheet and the first separator of the first cell, and
a second adhesive layer that adheres the rubber sheet and the second separator of the second cell.

7. The fuel cell stack according to claim 1, wherein the protrusion portion is a rib constituted by a bent portion of the first separator.
